(19) United States
(12) Patent Application Publication
(10) Pub. No.: US 2019/0383334 A1
(43) Pub. Date: Dec. 19, 2019

(54) Clutch Bearing Having Alignment Element for Clutch Spring

(71) Applicant: KNORR-BREMSE Systeme fuer Nutzfahrzeuge GmbH, Muenchen (DE)

(72) Inventors: Michel SAINTIVE, Le Pré d'Auge (FR); Jean-Baptiste MARESCOT, Manerbe (FR); Frederic AMIOT, Saint-Cyr-du-Ronceray (FR); Joerg MELLAR, Pliening (DE)

(21) Appl. No.: 16/556,413

(22) Filed: Aug. 30, 2019

Related U.S. Application Data
(63) Continuation of application No. PCT/EP2018/052804, filed on Feb. 5, 2018.

(30) Foreign Application Priority Data
Mar. 1, 2017 (DE) 10 2017 104 201.6

(51) Int. Cl. F16D 23/14; F16D 13/38; F16D 13/58

(52) U.S. Cl. CPC F16D 23/143; B60K 25/02; F16D 13/58; F16D 13/38

(57) ABSTRACT

A motor vehicle clutch for frictionally connecting and separating a drive assembly to/from an auxiliary assembly, has a bearing for transferring an axial force to at least one plate spring by way of a contact surface, for opening the clutch. The plate spring has spring tongues protruding radially inward, which have recesses between each other. The bearing has pins for radially immovable and rotationally fixed immobilizing of the plate spring, which pins extend from the contact surface in the axial direction of the motor vehicle clutch and are configured to be received by the recesses between the spring tongues and to engage therewith.

### CROSS REFERENCE TO RELATED APPLICATIONS

This application is a continuation of PCT International Application No. PCT/EP2018/052804, filed Feb. 5, 2018, which claims priority under 35 U.S.C. § 119 from German Patent Application No. 10 2017 104 201.6, filed Mar. 1, 2017, the entire disclosures of which are herein expressly incorporated by reference.

### BACKGROUND AND SUMMARY OF THE INVENTION

The present invention relates to a clutch bearing having an alignment element for a clutch spring which is embodied as a plate spring, as well as to a clutch for an auxiliary apparatus of a motor vehicle having such a clutch bearing. Such a clutch hereunder is referred to as a motor vehicle clutch.

Clutches in motor vehicles are used for separating on demand a force-fit between a drive apparatus and a gearbox. Moreover, clutches in motor vehicles are furthermore used for separating on demand the force-fit between the drive apparatus and an auxiliary apparatus. Such an auxiliary apparatus can be, for example, an air compressor, or a compressor, respectively. Commercial vehicles such as trucks or buses are in particular usually equipped with a pneumatic brake system which for the operation thereof requires compressed air. Besides a compressor, said vehicles furthermore have a pneumatic reservoir. In the event of said pneumatic reservoir during the operation of the vehicle being filled with compressed air and a predetermined nominal internal pressure being prevalent, driving the compressor by way of the drive apparatus is temporarily no longer required until the nominal internal pressure is undershot again on account of the operation of the pneumatic consumers. Rather, driving the compressor at this point in time is even undesirable since additional energy is consumed on account of any unnecessary driving action.

Such a clutch which is disposed between a drive apparatus and a compressor is typically embodied as a disk clutch and has a plurality of friction disks. Said friction disks for achieving a closed (force-fitting) clutch state are mutually compressed by means of one or a plurality of plate springs. In order for the clutch to be open, a counter force on the plate springs is built up by means of a pneumatic actuator so that the friction disks are relieved of the spring force of the plate springs.

A technical problem herein lies in that the position of the plate springs within the clutch has to be established in order for wear between the plate springs and the components in contact with said plate springs to be reduced. More specifically, the position of the plate springs in relation to the remaining clutch construction, in particular in relation to the clutch hub, has to be established. The plate springs in an installed state consequently must not be rotatable as well as not be radially displaceable in relation to the clutch hub.

The rotationally fixed connection between the clutch hub and the plate springs in EP 1 995 482 A1 is achieved in that the clutch hub and a plurality of locations have a slot in the axial direction in which the plate springs engage. Furthermore, the plate springs on the external diameter thereof are radially centered on the hub lock so that no movement of the plate springs is possible in the radial direction of the hub. In the case of such a construction, a high tolerance value has to be provided in terms of the radial centering of the plate springs since centering does not take place directly at the hub but at the hub lock (or at the clutch basket). On account thereof, the mutual position of the individual springs and the position of said springs in relation to the bearing is not exactly established so that increased wear arises on the fingers and on the springs. A further disadvantage of this construction lies in that a relative movement can arise between the bearing and the spring when the clutch is activated, this likewise leading to wear.

In EP 2 123 929 B1 only one plate spring is used so as to avoid the appearance of mutual wear between a plurality of plate springs that would otherwise be present. In order for rotationally fixed centering between the output element 32 and the plate spring to be achieved, the output element 32 has three groove-type depressions 114, in each case one spring tongue 112 which in the radial direction is embodied so as to be longer than the remaining spring tongues engages (cf. FIG. 4 of EP 2 123 929 B1). Centering or establishing, respectively, the plate spring in the radial direction is performed at the external circumference thereof. In the case of such a construction, the spring is indeed centered on the hub and on account thereof centered by way of a minor tolerance value. However, a relative movement between the bearing and the spring can also arise here when the clutch is activated, this increasing wear.

At least one of the problems above is solved by a motor vehicle clutch, a bearing, as well as a plate spring according to the claimed invention.

On account of a design embodiment according to the invention of the motor vehicle clutch, the bearing, as well as the plate spring(s), and alignment/centering of the plate spring(s) within the motor vehicle clutch is achieved by way of which alignment/centering an improved wear behavior of the plate springs per se as well of the parts in contact with said plate springs is implementable. The plate springs, by virtue of the design embodiment according to the invention, are rotatable about the clutch axis neither in relation to one another, nor in relation to the bearing. The spring tongues of the plate springs which are sensitive to wear are in particular treated gently on account thereof. In particular, the wear between the plate springs and the contact face thereof to the bearing is reduced, since the mobility between the spring tongues and the bearing is minimized. Furthermore, wear between the radially outward region of the plate springs and the hub is minimized.

According to one advantageous design embodiment, the stroke travel of the bearing for opening the motor vehicle clutch is achieved by way of direct contact (axial detent) between the bearing (in particular the pins of the bearing) and the axially non-displaceable hub, on account of which the maximum axial spring travel of the plate springs is delimited. The plate springs are treated gently on account thereof. Furthermore, controlling the activation of the clutch is simplified on account thereof.

According to one advantageous design embodiment, the bearing has a collar which extends in the axial direction of the clutch and which is disposed radially between the hub and the plate spring(s). On account thereof, frictional contact between the radially inward edge(s) of the plate spring(s) and the hub is prevented, wear being reduced on account thereof.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a motor vehicle clutch according to the invention in three sectional views, in a closed state of the clutch.

FIG. 2 shows the motor vehicle clutch according to the invention in three sectional views, in an open state of the clutch.

FIG. 3 shows the motor vehicle clutch according to the invention in a sectional detailed view.

FIG. 4 shows a plurality of embodiments of a bearing according to the invention having plate springs according to the invention.

FIG. 5A shows an isometric view of a bearing according to the invention.

FIG. 5B shows an isometric view of the bearing according to the invention, having a collar.

FIG. 5C shows a plate spring according to the invention.

### DETAILED DESCRIPTION OF THE DRAWINGS

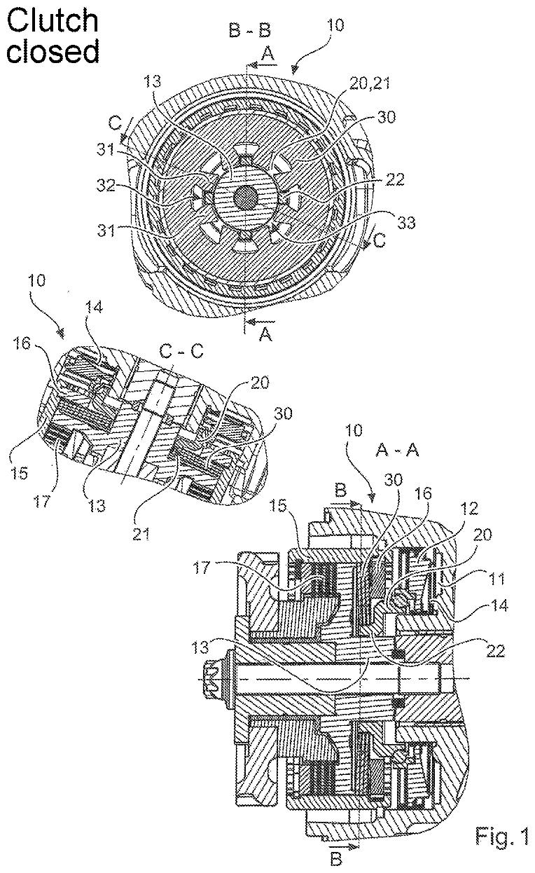

FIG. 1 shows three sectional views of a motor vehicle clutch 10 for connecting in a force-fitting manner a primary apparatus to a compressor. The motor vehicle clutch 10 is illustrated in a closed state of the clutch. A closed state of the clutch means that at this point in time a force-fitting connection between the primary apparatus and the compressor is established by way of the motor vehicle clutch. The disk pack 17 of the motor vehicle clutch 10 herein is pushed together; the individual friction disks move as an entity. The sections A-A as well as C-C which are illustrated below are plotted in the sectional view B-B illustrated above. FIG. 1 shows an assembled state of the motor vehicle clutch 10, wherein three plate springs 30 and one bearing 20 are shown in an assembled state. A plate spring 30 having a circular external circumference is illustrated in the sectional view B-B. The plate spring 30 has spring tongues 31 that are symmetrically disposed on the internal circumference of said plate spring 30. A spacing is in each case configured between the individual spring tongues 31. Said spacing is configured either by an intermediate space 33 between the spring tongues 31 or by a recess 32 between the spring tongues 31. The geometry of a recess 32 herein is adapted to the geometry of a pin 22 of the bearing 20. A pin 22 engages with the plate spring 30 between the flanks of each recess 32. A contact face 21 of the bearing 10 that is partially obscured by the plate spring 30 can be seen through the intermediate spaces 33. A hub 13 is furthermore illustrated in the center of the sectional view B-B.

The fundamental functional mode of the motor vehicle clutch 10 is illustrated in the sectional view C-C. The section C-C herein runs through two spring tongues 31. A spring force is exerted by the plate springs 30 on the bearing 20 by way of a planar contact between the radially inward region of the plate springs 30, more specifically between the radially inward region of the spring tongues 31 and the contact face 21 of the bearing 20. Furthermore, the plate springs 30 by way of a planar contact between the radially outward region of said plate springs 30 exert a spring force on the hub 13. The spring forces in this constellation cause a closed state of the clutch since the plate springs 30 in a region that lies between the radially outward regions and the radially inward regions of said plate springs 30 exert a spring force on a release ring 16 which is fixedly connected to an axially displaceable clutch basket 15. The outer disks of the clutch, which are part of the disk pack 17 are fastened to the axially displaceable clutch basket 15. The spring forces of the plate springs 30 push the release ring 16 conjointly with the clutch basket 15 to the right (in terms of the sectional view A-A), on account of which the disk pack 17 is likewise pushed to the right against the axially non-displaceable hub 13. On account thereof, the motor vehicle clutch 10 is in a closed state of the clutch.

On account of the disposal of more than two pins 22 on the bearing 20, of four pins 22 in the exemplary embodiment shown here, the plate springs 30 are centered on the bearing 20. Section B-B consequently shows the centering of the plate springs 30 on the bearing 20, wherein the section C-C illustrates the tension caused by the spring forces between the bearing 20, the hub 13, and the release ring 16.

The section A-A runs through two pins 22. The radially inward region of the plate springs 30 herein does not physically contact the external shell face of the pin 22. A pretensioning spring 14 which is disposed within a pressurized chamber 11 is furthermore illustrated in the section A-A. In order for the bearing 20 to be moved thus in order for the clutch to be activated, the pressurized chamber 11 is impinged with compressed air. The fluid pressure within the pressurized chamber 11 herein acts on a piston 12 which is operatively connected by force in a functional chain to the bearing 20. In order for a desired pretensioning to be achieved within said functional chain by force even without positive pressure within the pressurized chamber 11, the pretensioning spring 14 is disposed within the pressurized chamber 11. In the state shown in FIG. 1, there is either no positive pressure or only a minor positive pressure which either does not deform the plate springs 30, or deforms them only to a minor extent, prevalent within the pressurized chamber 11. The volume of the pressurized chamber 11 in this state is defined as the minimal volume.

In a further exemplary embodiment (not shown) there is no pretensioning spring 14 for pretensioning the functional chain by force present within the motor vehicle clutch.

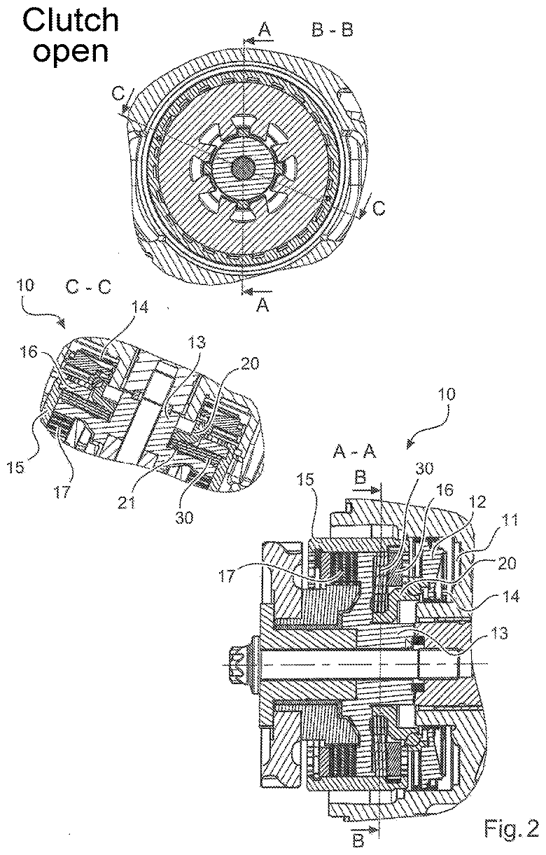

FIG. 2 illustrates the clutch device 10 from FIG. 1 by means of identical sections. Consequently, only the point of differentiation as compared to the illustration from FIG. 1 will be explained. However, another state, specifically the state having an open clutch, is shown. The illustration of the section B-B will not be discussed in more detail since there are no changes in relation to the section B-B from FIG. 1 herein. In order for the clutch to be activated, in this case for the motor vehicle clutch 10 to be opened, the pressurized chamber 11 proceeding from the state from FIG. 1 has been supplied with compressed air, on account of which the piston 12 (in terms of the sectional view A-A) conjointly with the bearing 20 has moved to the left until said bearing has axially impacted the hub 13. On account thereof, the plate springs 30 have been tilted. More specifically, the radially inward region of the plate springs 30 (in terms of the sectional view A-A) has been displaced to the left, wherein the radially outward region of the plate springs 30 has remained at the position of the axially non-displaceable hub 13. On account thereof, the contact point between the plate springs 30 and the release ring 16 has likewise been displaced to the left, on account of which the clutch basket 15 has been displaced to the left. The disk pack 17 has been de-stressed on account thereof; the inner disks and the outer disks in the state shown in FIG. 2 can consequently rotate in a mutually independent manner; the clutch is opened.

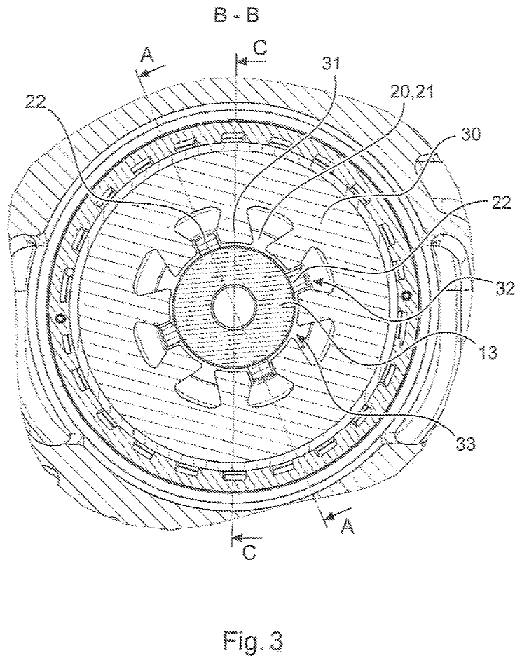

FIG. 3 shows the sections B-B from FIG. 1 and FIG. 2 in a detailed view, wherein the sections A-A and C-C are indeed plotted in another position but the section A-A nevertheless identifies a section through the pins 22 and the section C-C identifies a section through the spring tongues 31.

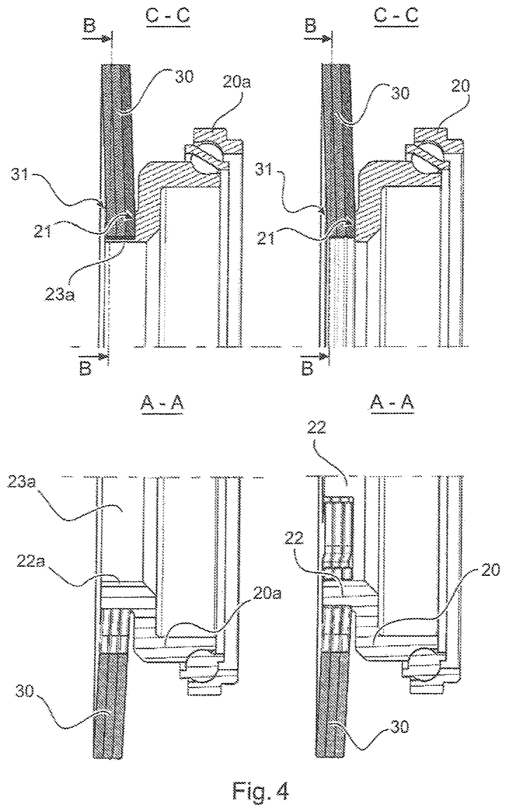

FIG. 4 shows the sections C-C and A-A from FIG. 3. The sections C-C and A-A on the right side of FIG. 4 herein show the exemplary embodiment of the bearing 20 from the preceding figures, however only the bearing 20 as well as the plate springs 30 are illustrated as components. In the section C-C (top right) the section runs through the spring tongues 31. Said spring tongues 31 in the axial direction bear on the contact face 21 of the bearing 20. The bearing 20 herein does not extend into the radially inward region of the plate springs 30, or of the spring tongues 31.

The sections C-C and A-A on the left side of FIG. 4 show an alternative exemplary embodiment of the bearing 20, specifically the bearing 20a. Said bearing 20a is identical to the bearing 20 described above, however in the case of the bearing 20a a cylindrical collar 23a extends from a contact face 21a (which correspond to the contact face 21 of the preceding exemplary embodiment) in the axial direction and herein extends into the radially inward region of the plate springs 30, or of the spring tongues 31, respectively. Consequently, the cylindrical collar 23a (when viewed in the vertical radial direction, respectively) extends between the radially inward region of the plate springs 30 (more specifically of the spring tongues 31) and the hub 13 (not illustrated).

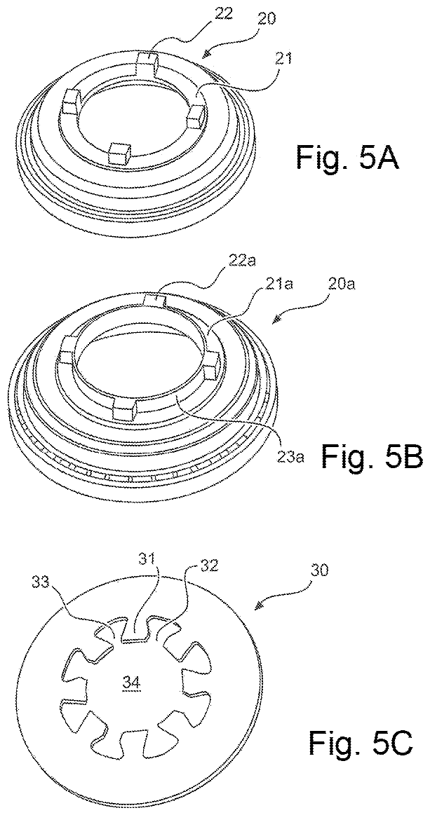

FIGS. 5A, 5B, and 5C show isometric views of the bearing 20 (FIG. 5A), of the bearing 20a (FIG. 5B), and of one of the plate springs 30. Four pins 22 which extend from the contact face 21 in the axial direction are illustrated in FIG. 5. FIG. 5A shows the alternative exemplary embodiment of the bearing 20, specifically the bearing 20a. The collar 23a extends in a cylindrical design on the pins 22a of said bearing 20a, or on the radially inward region of the pins 22a, respectively. FIG. 5C shows one of the plate springs 30 with the spring tongues 31, thereof; the recesses 32 (between the spring tongues) for receiving a pin 22, 22a, wherein the geometry of the recesses 32 as well as the geometry of the pins 22, 22a are mutually adapted; as well as the intermediate spaces 33 (between the spring tongues) which are smaller than the recesses 32, wherein the geometry of the intermediate spaces 33 and the geometry of the pins 22, 22a are not mutually adapted.

The pins 22, 22a correspond in each case to an alignment element for aligning and centering the plate spring(s) 30 on the bearing 20, 20a.

### LIST OF REFERENCE SIGNS

10 Motor vehicle clutch
11 Pressurized chamber
12 Piston
13 Hub
14 Pretensioning spring
15 Clutch basket
16 Release ring
17 Disk pack
20, 20a Bearing
21, 21a Contact face
22, 22a Pin (on contact face of the bearing); alignment element
23a Collar
30 Plate spring
32 Spring tongues
32 Recess (between spring tongues)
33 Intermediate spaces (between spring tongues)

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motor vehicle clutch for frictionally connecting and separating a drive apparatus to/from an auxiliary apparatus, comprising:
a bearing for transmitting an axial force to at least one plate spring by way of a contact face for activating the clutch, wherein
the plate spring has radially inward-protruding spring tongues which therebetween have recesses,
the bearing for establishing the plate spring in a radially non-displaceable as well as rotationally fixed manner has pins which extend from the contact face in the axial direction of the motor vehicle clutch and are configured to be received by the recesses between the spring tongues and to engage with said recesses.

2. The motor vehicle clutch as claimed in claim 1, wherein
the bearing on an internal circumference thereof has a collar which extends in the axial direction and extends through an internal opening of the plate spring.

3. The motor vehicle clutch as claimed in claim 1, further comprising:
a hub, wherein
the motor vehicle clutch is constructed such that the hub in an axial movement of the bearing for opening the motor vehicle clutch serves as a detent for the bearing.

4. The motor vehicle clutch as claimed in claim 1, wherein
the drive apparatus is an internal combustion engine, and
the auxiliary apparatus is a compressor.

5. A bearing for activating a motor vehicle clutch, wherein the bearing is configured for transmitting an axial force to at least one plate spring by way of a contact face, wherein the plate spring has radially inward-protruding spring tongues which therebetween have recesses, comprising:
pins on the bearing for establishing the plate spring in a radially non-displaceable as well as rotationally fixed manner, wherein the pins extend from the contact face in an axial direction of the motor vehicle clutch and are configured to be received by the recesses between the spring tongues and to engage with said recesses.

6. The bearing as claimed in claim 5, wherein
the bearing on an internal circumference thereof has a collar which extends in the axial direction and is configured for extending through an internal opening of the plate spring.

7. The bearing as claimed in claim 5, wherein
the bearing is a ball bearing or a roller bearing.

8. A plate spring for use in a motor vehicle clutch, comprising:
radially inward-protruding spring tongues of the plate spring, wherein the spring tongues therebetween have recesses, and
the recesses are configured for engaging with pins of a bearing, said pins extending in the axial direction of the motor vehicle clutch such that the plate spring in relation to the bearing is established so as to be radially non-displaceable as well as rotationally fixed.
